(19) United States
(12) Patent Application Publication
(10) Pub. No.: US 2006/0234553 A1
(43) Pub. Date: Oct. 19, 2006

(54) Electrical connector with a metal housing

(76) Inventor: Chou Hsuan Tsai, Hsin-Chuang City (TW)

Correspondence Address: PRO-TECTOR INTERNATIONAL SERVICES, 20775 NORADA CT., SARATOGA, CA, 95070, US

(21) Appl. No.: 11/398,393

(22) Filed: Apr. 4, 2006

(30) Foreign Application Priority Data
Apr. 15, 2005 (TW) 094205975

(51) Int. Cl. H01R 13/648

(52) U.S. Cl. 439/607

(57) ABSTRACT

An electrical connector includes a plastic base, a plurality of terminals, a metal housing and a hooking element. The plastic base is formed with a connection portion. The terminals are disposed in the plastic base. Each of the terminals has a pin portion extending out of the plastic base. The metal housing covers the plastic base while exposing the connection portion of the plastic base and the pin portions of the terminals. The hooking element is electrically connected to the metal housing and extends below the plastic base to be connected to a circuit board. The hooking element includes two metal sheets, which are connected together, have corresponding shapes, and are folded and stacked together.

### BACKGROUND OF THE INVENTION

1. Field of the Invention

The invention relates to an electrical connector, and more particularly to an electrical connector with a metal housing.

2. Description of the Related Art

Referring to FIGS. 1 and 2, a conventional dual-layer USB electrical connector to be connected to USB (Universal Serial Bus) plugs includes a plastic base 10, a metal housing 20 and a front fitting part 30. A front end of the plastic base 10 is formed with a baffle 11 and two connection portions 12. A plurality of terminals 13 is disposed in the plastic base 10. The metal housing 20 covers the plastic base 10 while exposing the connection portions 12 and pin portions of the terminals 13. The top and bottom plates of the metal housing 20 are pressed to form elastic engaging pieces 21. Each elastic engaging piece 21 is formed with a projecting engaging portion 22 at a distal end. Two side plates of the metal housing 20 are pressed to form elastic grounding pieces 23. Two sides of the bottom of the metal housing 20 are formed with plate-engaging hooks 24. Two sides of the front end of the metal housing 20 are formed with engagement holes 25. The front fitting part 30 has a [symbol] -shaped cross-sectional area. Two surfaces of the front fitting part 30 are formed with elastic engaging pieces 31. The elastic engaging piece 31 is formed with a projecting engaging portion 32 near a distal end thereof. Two sides of the elastic engaging piece 31 are formed with hooks 33. The front fitting part 30 fits with the baffle 11 of the plastic base 10 and is fixed to the engagement holes 25 of the metal housing 20 through the hooks 33.

According to the above-mentioned structure, when a USB plug 35 is inserted into one of the connection portions 12, engagement holes 36 on the top and bottom surfaces of the plug 35 engage with the engaging portions 22 of the elastic engaging piece 21 of the metal housing 20 and the engaging portions 32 of the elastic engaging piece 31 of the front fitting part 30.

The prior art has the following drawbacks. Because the top and bottom surfaces of the metal housing 20 are pressed to form two elastic engaging pieces 21 for engaging with the engagement holes 36 of the USB plug 35 and the lower edge of the metal housing is integrally formed with the plate-engaging hooks 24, the elastic engaging piece 21 and the plate-engaging hook 24 must have the proper intensity in order to achieve the firm engaging and hooking effects. Thus, it is impossible to utilize a thinner plate to form the metal housing 20, or otherwise the intensity and the resilience of each of the elastic engaging piece 21 and the plate-engaging hook 24 are insufficient, and the effect of saving the material cannot be achieved.

### SUMMARY OF THE INVENTION

It is therefore an object of the invention to provide an electrical connector having a metal housing and a hooking element made of a metal plate. The metal plate is shaped and then folded and stacked together such that the thickness of the folded metal plate equals twice that of the metal plate and the intensity of the hooking element is enhanced.

Another object of the invention is to provide an electrical connector with a metal housing such that the preparation of the material is simplified and the material cost of the large-area metal housing is reduced.

To achieve the above-identified objects, the invention provides an electrical connector including a plastic base, a plurality of terminals, a metal housing and a hooking element. The plastic base is formed with a connection portion. The terminals are disposed in the plastic base. Each of the terminals has a pin portion extending out of the plastic base. The metal housing covers the plastic base while exposing the connection portion of the plastic base and the pin portions of the terminals. The hooking element is electrically connected to the metal housing and extends below the plastic base to be connected to a circuit board. The hooking element includes two metal sheets, which are connected together, have corresponding shapes, and are folded and stacked together.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a pictorially exploded view showing a conventional electrical connector.

FIG. 2 is a pictorially assembled view showing the conventional electrical connector.

FIG. 3 is a pictorially exploded view showing an electrical connector according to a first embodiment of the invention.

FIG. 4 is a pictorially assembled view showing the electrical connector according to the first embodiment of the invention.

FIG. 5 is a pictorially exploded view showing a plastic housing and engaging elements according to the first embodiment of the invention.

FIG. 6 is a pictorial view showing a front housing of a metal housing according to the first embodiment of the invention.

FIG. 7 is a pictorial view showing the formation of the engaging element according to the first embodiment of the invention.

FIG. 8 is a pictorial view showing the formation of a metal housing according to a second embodiment of the invention.

FIG. 9 is a pictorially exploded view showing an electrical connector according to a third embodiment of the invention.

FIG. 10 is a pictorially assembled view showing the electrical connector according to the third embodiment of the invention.

FIG. 11 is a pictorially exploded view showing a plastic housing, hooking elements and engaging elements according to the third embodiment of the invention.

FIG. 12 is a pictorial view showing the formation of the hooking element according to the third embodiment of the invention.

FIG. 13 is a pictorially assembled view showing an electrical connector according to a fourth embodiment of the invention.

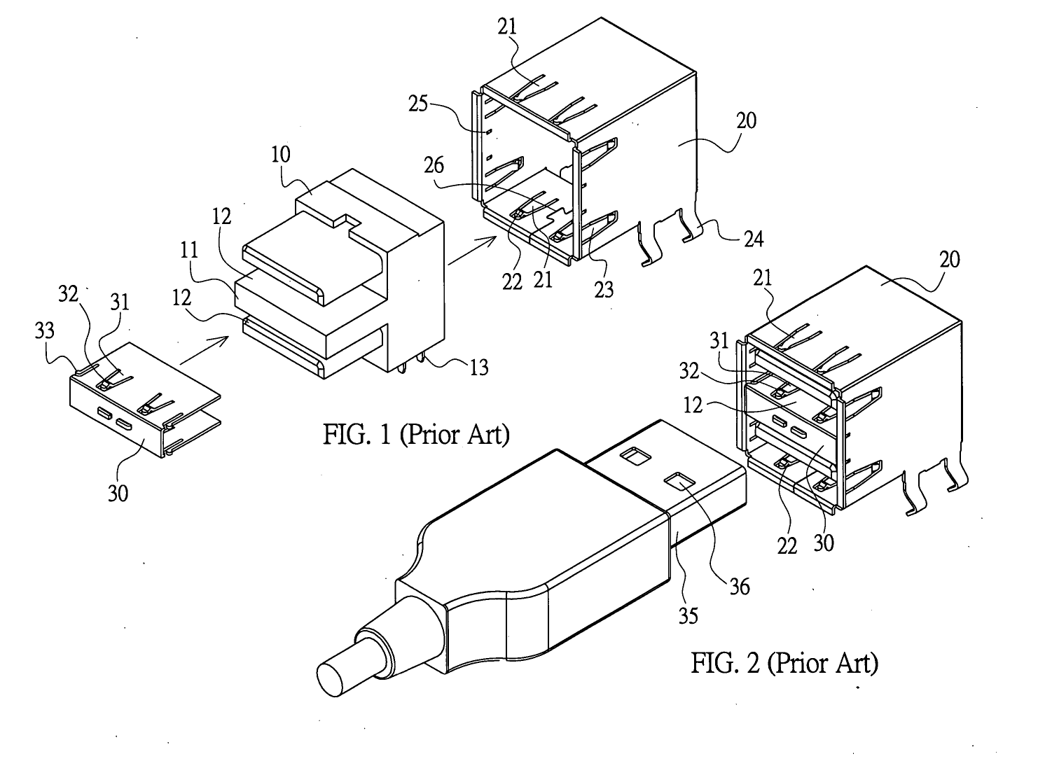

### DETAILED DESCRIPTION OF THE INVENTION

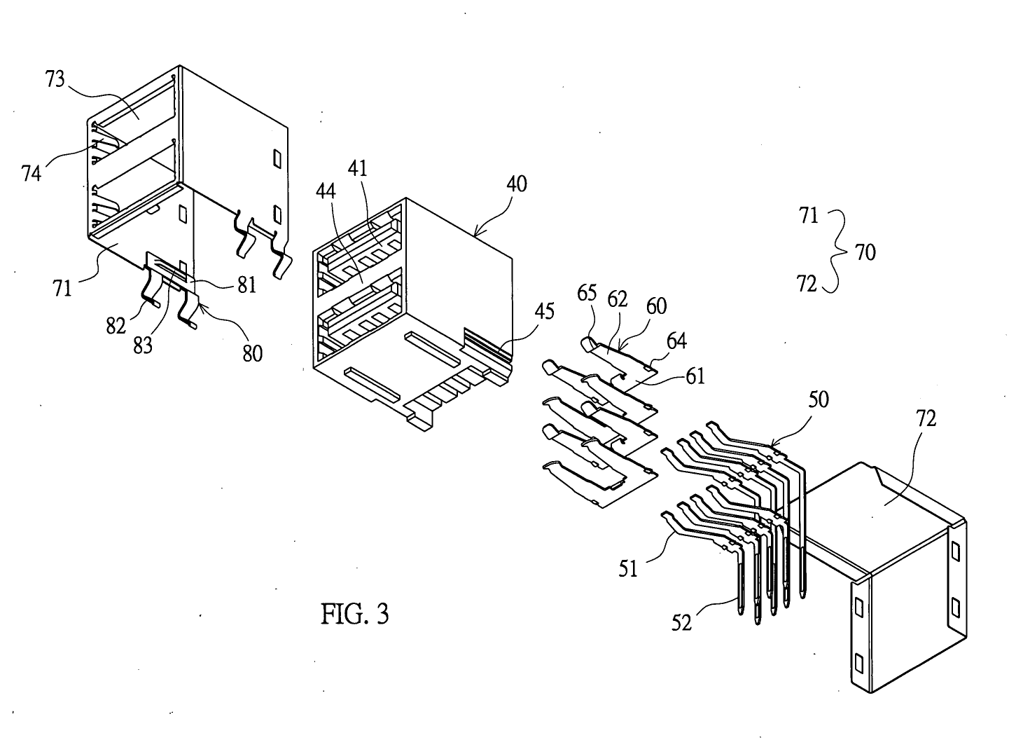

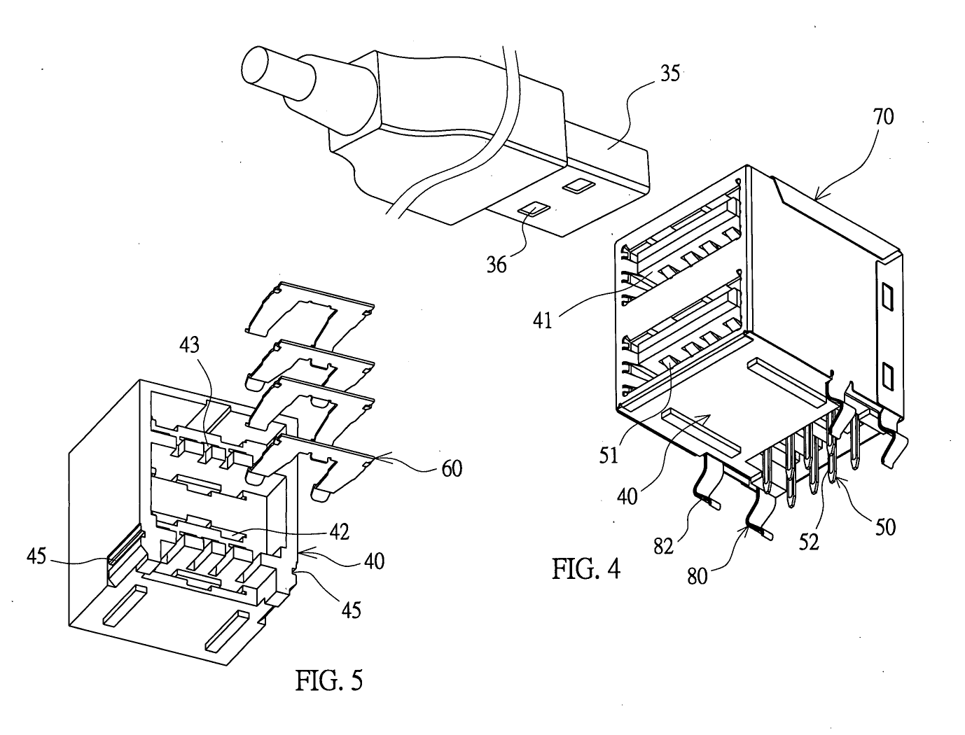

As shown in FIGS. 3 and 4, a dual-layer USB electrical connector according to the first embodiment of the invention is to be electrically connected to two USB plugs 35. Each USB plug 35 is formed with at least one engagement hole 36. The connector includes a plastic base 40, terminals 50, four engaging elements 60, two hooking elements 80 and one metal housing 70.

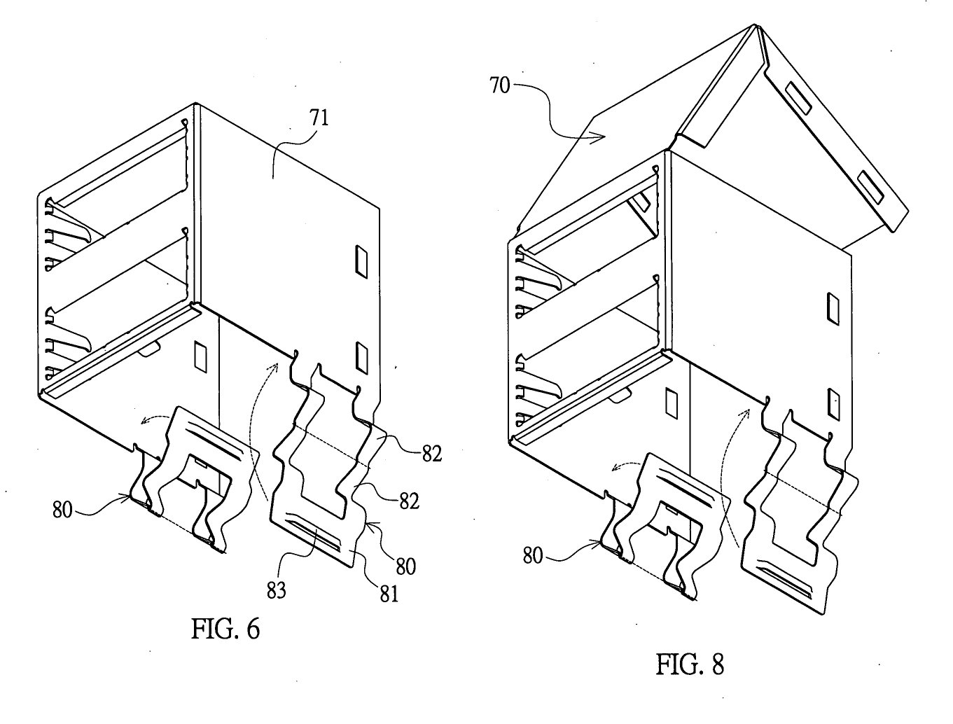

The plastic base 40 is formed with at least two connection portions 41 and terminal slots 43. The front end of the connection portion 41 is formed with an inserting port into which the USB plug 35 may be inserted. As shown in FIG. 5, two positioning slots 42 are formed at the rear side of each connection portion 41, and one baffle 44 is formed between the two connection portions 41. Slots 45 are formed at two sides of the lower end of the plastic base 40.

Each terminal 50 is inserted into the terminal slot 43 of the plastic base 40 and has a contact 51 located in the connection portion 41 and a pin portion 52 extending below the plastic base 40.

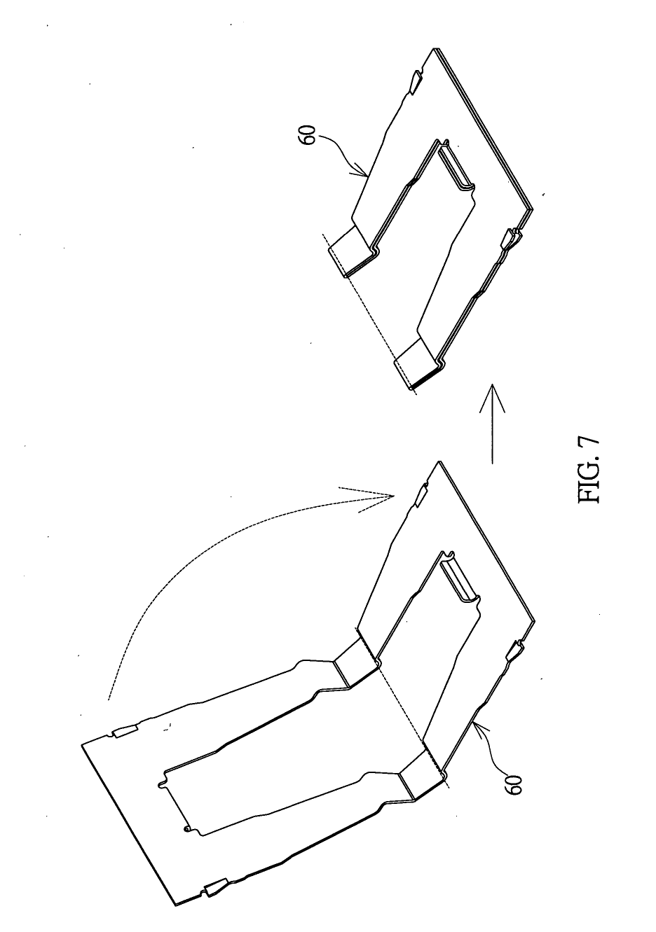

The engaging element 60 and the metal housing 70 pertain to different parts. The engaging element 60 has a fixing portion 61 and two elastic engaging pieces 62 to form an inverse-U shape. Two sides of the fixing portion 61 are formed with projections 64. Each engaging element 60 is assembled into the connection portion 41 from a positioning slot 42 at the rear end of the plastic base 40 and is pushed and fixed inside the plastic base 40 through the projection 64. The elastic engaging piece 62 of the engaging element 60 is located within the connection portion 41 of the plastic base 40. A projecting engaging portion 65 for engaging with the engagement hole 36 of the USB plug is formed near a distal end thereof. As shown in FIG. 7, the engaging element 60 includes two metal sheets, which are formed by pressing a stainless steel plate with the thickness of 0.1 mm and connected together, have corresponding shapes, and are folded and stacked together such that the thickness of the stacked metal sheets equals twice that of the stainless sheet plate.

The metal housing 70 is made by bending the stainless steel plate or another stainless steel plate with the thickness of 0.1 mm and includes a front housing 71 and a rear housing 72 assembled together. The front housing 71 has a front plate and two side plates. The rear housing 72 having a top plate and a rear plate covers the plastic base 40. The bottom of the metal housing 70 is open and the front housing 71 has two openings 73 and multiple elastic grounding pieces 74 connected to the periphery of the openings 73. The two connection portions 41 of the plastic base 40 and the pin portions 52 of the terminals 50 are exposed to the outside through the openings 73 and the open bottom.

The hooking element 80 integrally connected to the bottom of the metal housing 70 includes a fixing portion 81 and two elastic hooks 82. The fixing portion 81 is formed with a projection 83 engaging with the slot 45 on each side of the plastic base 40. The elastic hook 82 projects over the bottom of the plastic base 40 to engage with a connection hole of a circuit board. As shown in FIG. 6, the hooking element 80 is formed by pressing the bottom of the metal housing 70 to form two metal sheets, which are connected together and have the shape corresponding to the elastic hook 82 and are folded and stacked together. One of the hooking elements 80 further has a fixing portion 81 composed of two metal sheets stacked together. Thus, the thickness of the elastic hook 82 equals twice that of the metal plate.

Because the engaging element 60, the hooking element 80 and the metal housing are made of the same metal plate, and the engaging element 60 and the hooking element 80 have the thickness, which is twice that of the metal plate, the intensity of each of the engaging element 60 and the hooking element 80 is enhanced. Because the thickness of the metal housing is only 0.1 mm, the material cost can be greatly reduced.

The invention has the following advantages.

First, the parts may be formed using a thin metal plate (e.g., the stainless steel plate with the thickness of 0.1 mm). So, the material preparation is simplified, and the material cost of the large-area metal housing can be reduced.

Second, the thickness of each of the small-area engaging element 60 and the hooking element 80 equals twice that of the metal plate so that the sufficient intensity can be provided.

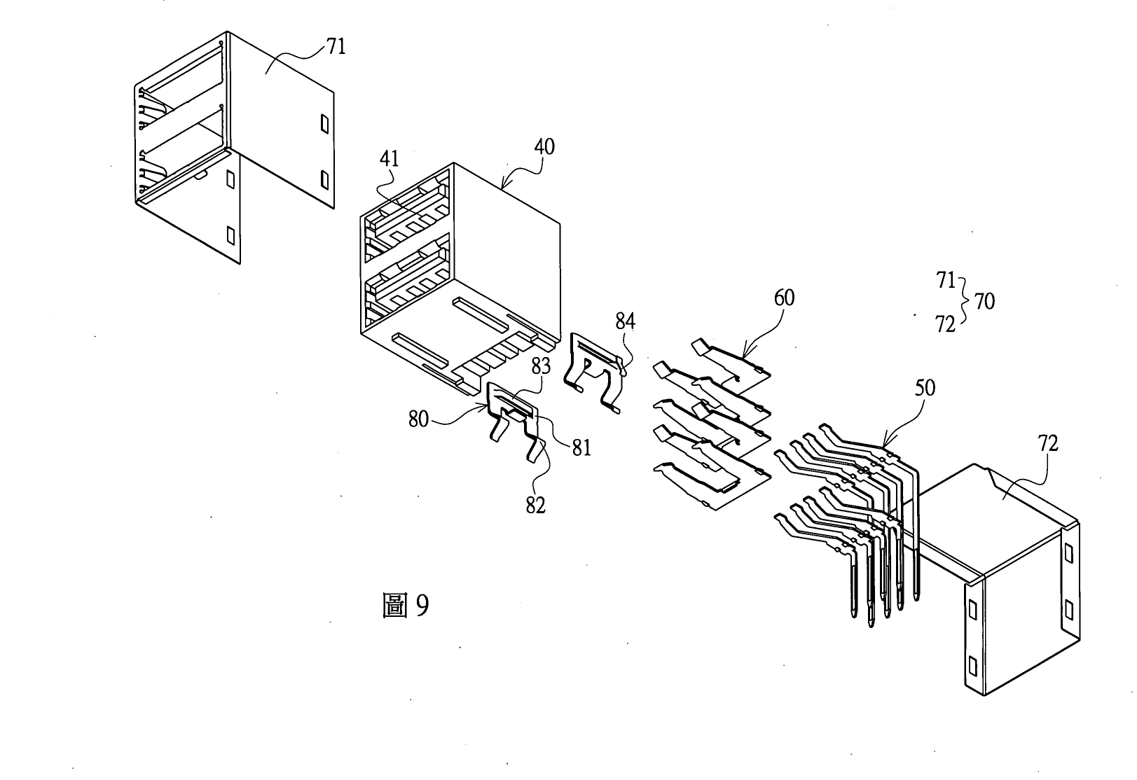

As shown in FIG. 8, the second embodiment of the invention is almost the same as the first embodiment except that the metal housing 70 of the second embodiment is integrally formed with a front surface, a rear surface, two side surfaces and a top surface.

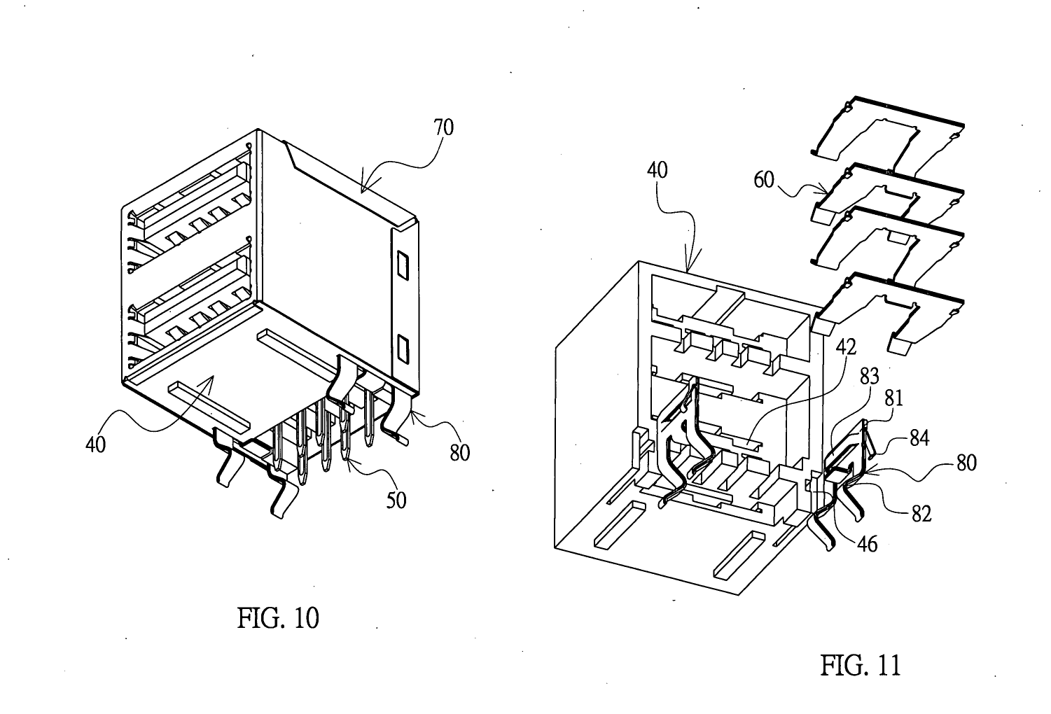

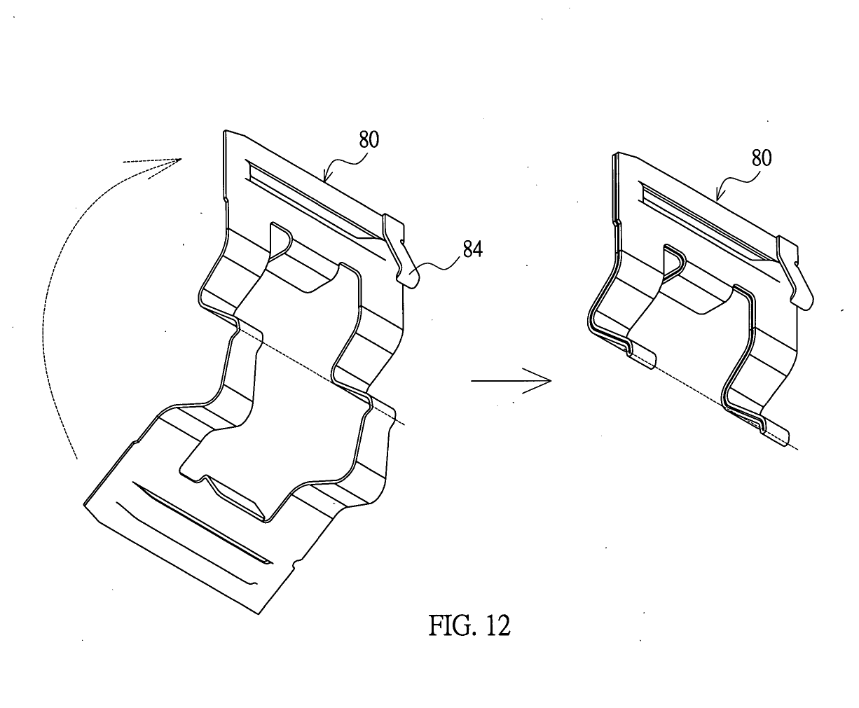

As shown in FIGS. 9 and 10, the third embodiment of the invention is almost the same as the first embodiment except that the hooking element 80 and the metal housing 70 pertain to different parts in the third embodiment. The hooking element 80 has a fixing portion 81 and two elastic hooks 82. The fixing portion 81 has a projection 83 and an elastic piece 84. As shown in FIG. 11, slots 46 are formed near two sides of the rear end of the plastic base 40. The projection 83 of the fixing portion 81 of the hooking element 80 engages with the slot 46. As shown in FIG. 12, the hooking element 80 is made by pressing a stainless steel plate with the thickness of 0.1 mm to form two metal sheets, which are connected together, have corresponding shapes, and are folded, stacked and pressed such that the thickness of the stacked metal sheets equals twice that of the metal plate. One of the hooking elements 80 is formed with an elastic piece 84, which has the thickness equal to that of the metal plate.

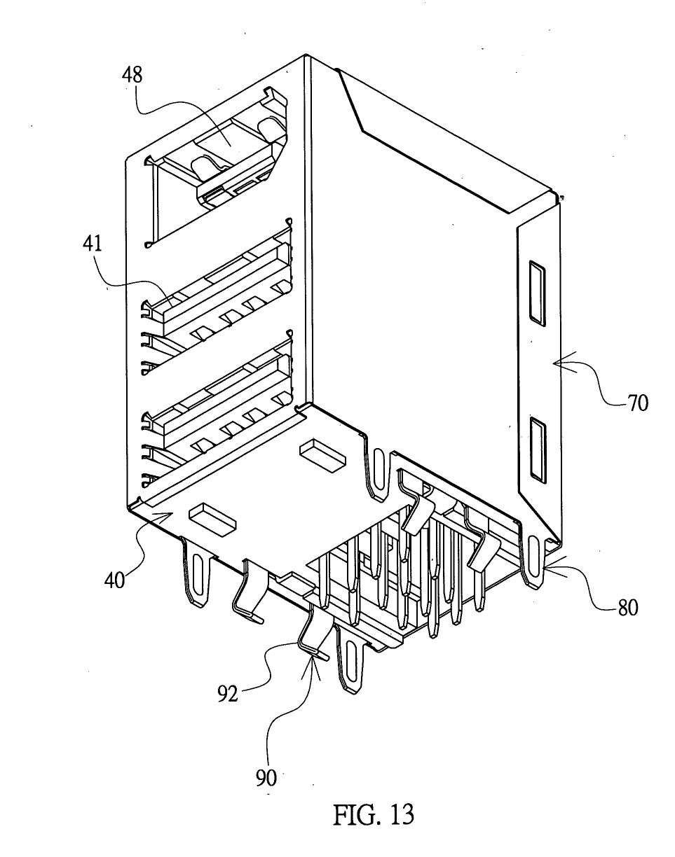

As shown in FIG. 13, the fourth embodiment of the invention is almost the same as the first embodiment except that the connector of this embodiment is to be electrically connected to two USB plugs and one high speed serial bus (e.g., IEEE1394) plug. That is, the plastic base 40 has two connection portions 41 to be electrically connected to the two USB plugs, and one connection portion 48 to be electrically connected to the IEEE1394 plug. In addition, the metal housing 70 is formed by bending a metal plate. Two sides of the lower edge of the metal housing 70 are integrally formed with one hooking element 80, which is a longitudinal plate and has the thickness of two metal plates. In addition, two plate-engaging elements 90 are assembled on the plastic base 40. The plate-engaging element 90 has two elastic hooks. 92 projecting out of the plastic base 40. The plate-engaging element 90 is also formed by pressing the metal plate of the metal housing 70 into two metal sheets, which are connected together, have corresponding shapes and are then folded and stacked together such that the thickness of the plate-engaging element 90 equals twice that of the metal plate.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electrical connector, comprising:
a plastic base formed with at least one connection portion;
a plurality of terminals disposed in the plastic base, each of the terminals having a pin portion extending out of the plastic base;
a metal housing covering the plastic base while exposing the at least one connection portion of the plastic base and the pin portions of the terminals; and
at least one hooking element, which is electrically connected to the metal housing and extends below the plastic base to be connected to a circuit board, wherein the at least one hooking element comprises two metal sheets, which are connected together, have corresponding shapes, and are folded and stacked together.

2. The connector according to claim 1, wherein the at least one hooking element has at least one elastic hook for hooking the circuit board.

3. The connector according to claim 1, wherein the plastic base is formed with a slot, the at least one hooking element and the metal housing pertain to different parts, and the at least one hooking element has a fixing portion engaging with the slot of the plastic base.

4. The connector according to claim 3, wherein the at least one hooking element has an elastic piece elastically contacting the metal housing.

5. The connector according to claim 4, wherein a thickness of the elastic piece equals a thickness of each of the metal sheets.

6. The connector according to claim 1, wherein the metal housing is formed by pressing and bending a metal plate.

7. The connector according to claim 6, wherein the at least one hooking element is integrally connected to a bottom of the metal housing.

8. The connector according to claim 1, further comprising at least one engaging element, wherein:
the at least one engaging element and the metal housing pertain to different parts;
the at least one engaging element has a fixing portion fixed to the plastic base, and at least one elastic engaging piece located in the at least one connection portion of the plastic base;
a projecting engaging portion is disposed near a distal end of the at least one engaging element; and
the at least one engaging element comprises two metal sheets, which are connected together, have corresponding shapes, and are folded and stacked together.

9. The connector according to claim 1, wherein the plastic base has at least two kinds of connection portions for different connecting purposes.

10. The connector according to claim 9, wherein the plastic base has two connection portions for USB plugs and one connection portion for an IEEE1394 plug.

11. The connector according to claim 9, wherein the plastic base has two connection portions for USB plugs and one connection portion for an RJ45 plug.
